(19) United States
(12) Patent Application Publication
(10) Pub. No.: US 2018/0263093 A1
(43) Pub. Date: Sep. 13, 2018

(54) LIGHT EMISSION LUMINANCE ADJUSTMENT DEVICE

(71) Applicant: TOSHIBA TEC KABUSHIKI KAISHA, Tokyo (JP)

(72) Inventor: Mitsuhiro Nozaki, Mishima Shizuoka (JP)

(21) Appl. No.: 15/904,171

(22) Filed: Feb. 23, 2018

(30) Foreign Application Priority Data
Mar. 8, 2017 (JP) 2017-044173

(51) Int. Cl. H05B 37/02; H05B 33/08; G08B 5/36

(52) U.S. Cl. CPC H05B 37/02; G08B 5/36; H05B 33/0845

(57) ABSTRACT

A light emission luminance adjustment device includes a first signal pulse generator configured to generate a first driving signal for controlling a lighting state of a first indicator light, and a second signal pulse generator configured to generate a second driving signal controlling a lighting state of a second indicator light. The first driving signal and the second driving signal are set to cause the first indicator light and the second indicator light to light at substantially equal brightness.

### CROSS-REFERENCE TO RELATED APPLICATION

This application is based upon and claims the benefit of priority from Japanese Patent Application No. 2017-044173, filed Mar. 8, 2017, the entire contents of which are incorporated herein by reference.

### FIELD

Embodiments described herein relate generally to a light emission luminance adjustment device.

### BACKGROUND

In the related art, an electronic device such as a personal computer or a printer automatically activates a sleep mode to conserve battery power by limiting CPU performance when the electronic device is idle over a predetermined period of time. Such an electronic device typically has a light emitting diode (LED) indicator that indicates the CPU is in the sleep mode or the non-sleep mode. When the CPU is awake (in the non-sleep mode), the CPU powers the LED indicator. When the CPU is in the sleep mode, the CPU may be turned off and power is not supplied to the LED indicator from the CPU. Thus, the LED indicator is operated by an external power source.

However, since the LED is powered differently when the CPU is in the non-sleep mode than when the CPU is in the sleep mode, brightness of the LED may be different. Such a difference in brightness may cause the LED to not clearly indicate the operation mode of the CPU to a user.

### DESCRIPTION OF THE DRAWINGS

FIG. 1 is an exterior perspective view of a label printer according to a first embodiment.

FIG. 2 is a schematic block diagram of a label printer.

FIG. 3 is a block diagram of an LED luminance adjustment unit in a label printer according to the first embodiment.

FIG. 4 is an example timing chart of a first driving signal.

FIG. 5 is an example circuit block diagram of a LED luminance adjustment unit in a label printer according to the first embodiment.

FIG. 6 is a timing chart illustrating an ON state of a LED luminance adjustment unit in a label printer according to the first embodiment.

FIG. 7 is a block diagram of an LED luminance adjustment unit in a label printer according to a second embodiment.

FIG. 8 is an example circuit block diagram of a LED luminance adjustment unit in a label printer according to the second embodiment.

FIG. 9 is a timing chart illustrating an ON state of a LED luminance adjustment unit in a label printer according to the second embodiment.

### DETAILED DESCRIPTION

According to an embodiment, a light emission luminance adjustment device includes a first signal pulse generator configured to generate a first driving signal for controlling alighting state of a first indicator light, and a second signal pulse generator configured to generate a second driving signal controlling a lighting state of a second indicator light. The first driving signal and the second driving signal are set to cause the first indicator light and the second indicator light to light at substantially equal brightness.

Hereinafter, label printers according to example embodiments will be described with reference to the drawings. It should be noted, that the particular embodiments explained below are some possible examples of an electronic device which includes a light emission luminance adjustment device according to the present disclosure and do not limit the scope of the present disclosure and other electronic device types may incorporate light emission luminance adjustment devices as disclosed.

### First Embodiment

Hereinafter, a label printer according to a first embodiment will be described.

Descriptions of Overall Configuration of Label Printer

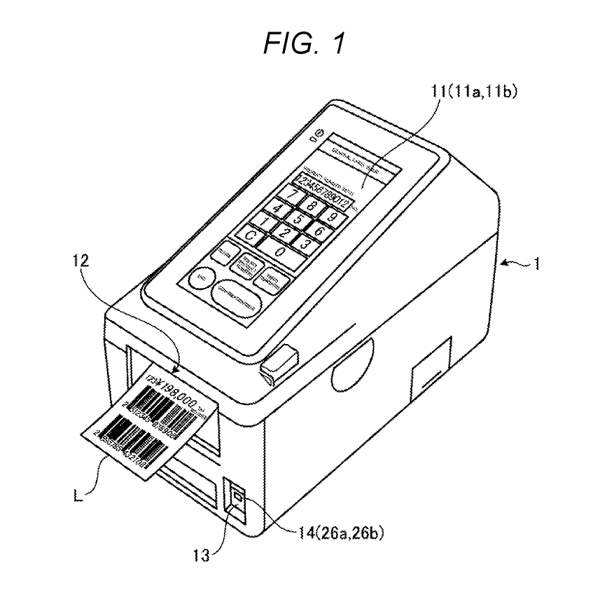

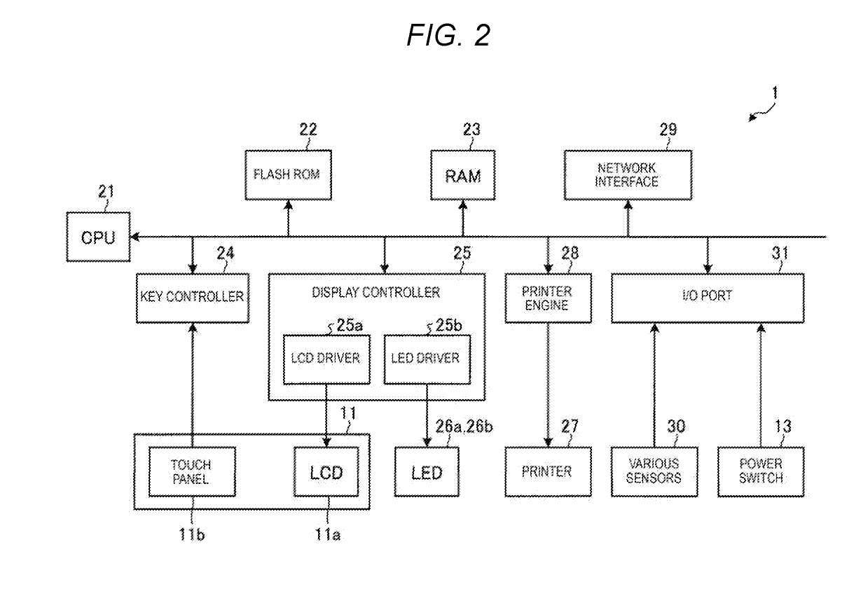

FIG. 1 is an exterior perspective view of a label printer 1 according to the first embodiment. The label printer 1 prints a price tag which is to be attached to a commodity. The label printer 1 includes a display and input unit 11 and a label issue port 12. The display and input unit 11 displays information for an operator and receives an instruction from the operator. The label issue port 12 is used for issuing a label L to be attached to a commodity. The label printer 1 includes a power switch 13 and a mode indicator 14 configured to display an operation mode of the label printer 1. The mode indicator 14 has a first and a second LEDs 26a and 26b mounted therein. The first LED 26a is an example of a first illuminant and is, for example, a green LED. The first LED 26a is ON when a CPU 21 (see FIG. 2) of the label printer 1 is in non-sleep mode. The second LED 26b is an example of a second illuminant and is, for example, an orange LED. The second LED 26b is ON when the CPU 21 of the label printer 1 is in sleep mode. In sleep mode, functions/operations of the CPU are limited to conserve power while, for example, the electronic device including the CPU is idle for a predetermined time. In the example embodiment described herein, an LED is used as an illuminant that indicates the CPU in sleep mode or non-sleep mode. However, the illuminant is not limited to an LED, and may be electro-luminescence (EL), a fluorescent tube, a lamp, and the like.

FIG. 2 is a schematic block of the label printer 1 according to the first embodiment. The label printer 1 includes a central processing unit (CPU) 21 as a control unit, a flash read only memory (ROM) 22, and a random access memory (RAM) 23. The flash ROM 22 stores a control program, fixed data, or the like. The RAM 23 stores various types of data.

The label printer 1 includes a network interface 29, a key controller 24, a display controller 25, a printer engine 28, and an I/O port 31. The network interface 29 transmits and receives various types of setting data to and from an external device such as a store server (not illustrated). The key controller 24 is disposed on a display surface of a LCD 11a in the display and input unit 11, and receives input data from a touch panel 11b.

The display controller 25 includes an LCD driver 25a and an LED driver 25b. The LCD driver 25a controls the LCD 11a of the display and input unit 11 to display various setting screens. The LED driver 25b controls ON/OFF states of the first and the second LEDs 26a and 26b in the mode indicator 14. The printer engine 28 controls a printer 27 to print a label L in accordance with a label format and the like which are set. When the label L is printed, the I/O port 31 performs transmission and reception of a signal between various sensors 30 configured to, for example, detect a temperature and the power switch 13, and the CPU 21.

The CPU 21 is connected to the flash ROM 22, the RAM 23, the network interface 29, the key controller 24, the display controller 25, the printer engine 28, and the I/O port 31 by a bus line.

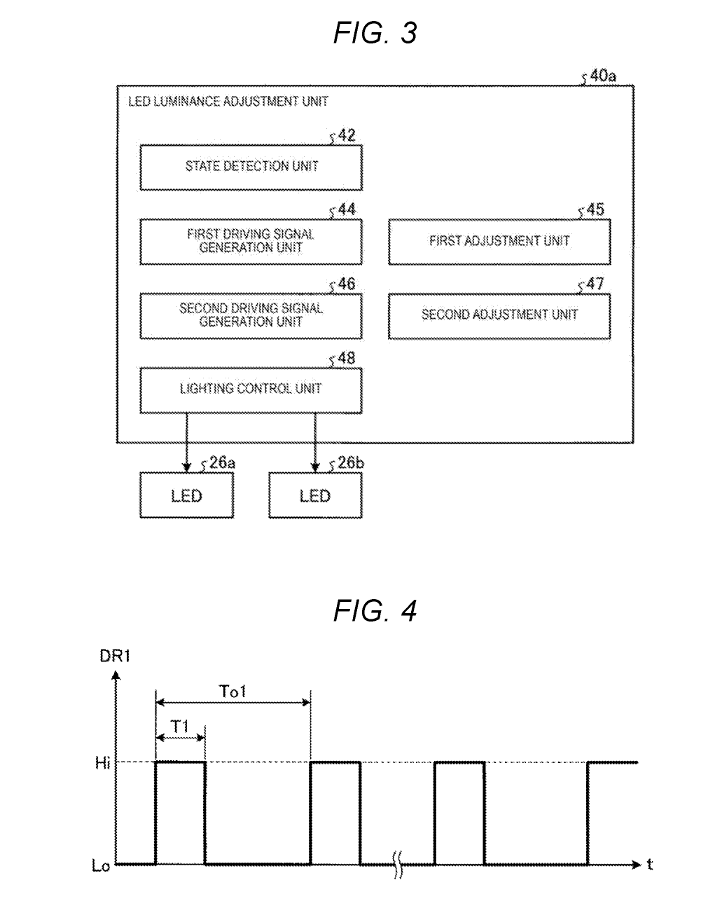

The control program executed by the CPU 21 cooperates with the display controller 25, so as to constitute an LED luminance adjustment unit 40a (see FIG. 3). The LED luminance adjustment unit 40a is an example of the light emission luminance adjustment device, and controls the first LED 26a to light when the CPU 21 is in sleep mode. The LED luminance adjustment unit 40a controls the second LED 26b to light when the CPU 21 is in non-sleep mode. The LED luminance adjustment unit 40a controls the first LED 26a and the second LED 26b to light such that brightness of the first LED 26a is substantially equal to brightness of the second LED 26b.

Descriptions of Functional Configuration of LED Luminance Adjustment Unit

Next, a functional configuration of the LED luminance adjustment unit 40a will be described with reference to FIG. 3. FIG. 3 is a block diagram of the LED luminance adjustment unit 40a.

The LED luminance adjustment unit 40a includes a state detection unit 42, a first driving signal generation unit 44, a first adjustment unit 45, a second driving signal generation unit 46, a second adjustment unit 47, and a lighting control unit 48. The state detection unit 42 detects whether the CPU 21 is in sleep mode or in non-sleep mode. The CPU 21 functions as the state detection unit 42.

The first driving signal generation unit 44 is a signal pulse generator and an example of a first signal generation means. The first driving signal generation unit 44 generates and outputs a first driving signal DR1 (see FIG. 4) for controlling the lighting state of the first LED 26a, when the state detection unit 42 detects that the CPU 21 is in non-sleep mode. The CPU 21 functions as the first driving signal generation unit 44.

The first adjustment unit 45 is an example of first adjustment means and adjusts a pulse width T1 and a period To1 (see FIG. 4) of the first driving signal DR1. The CPU 21 functions as the first adjustment unit 45. Specifically, the pulse width T1 and the period To1 of the first driving signal DR1, which are saved in the control program executed by the CPU 21 are adjusted, and thus the first driving signal DR1 is adjusted so as to cause brightness of the first LED 26a to be substantially equal to brightness of the second LED 26b.

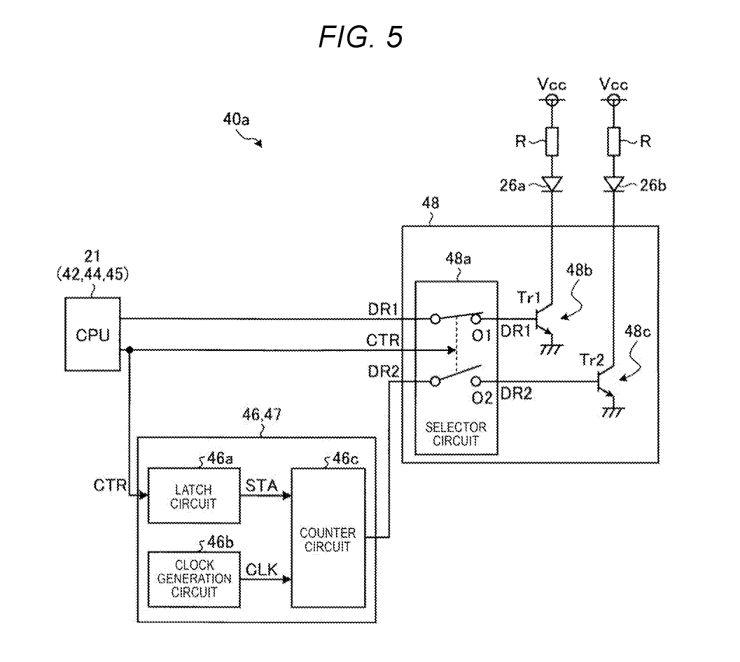

The second driving signal generation unit 46 is a signal pulse generator and an example of a second signal generation means. The second driving signal generation unit 46 generates and outputs a second driving signal DR2 (see FIG. 5) for controlling the lighting state of the second LED 26b, when the state detection unit 42 detects that the CPU 21 is in sleep mode. The display controller 25 in FIG. 2 functions as the second driving signal generation unit 46.

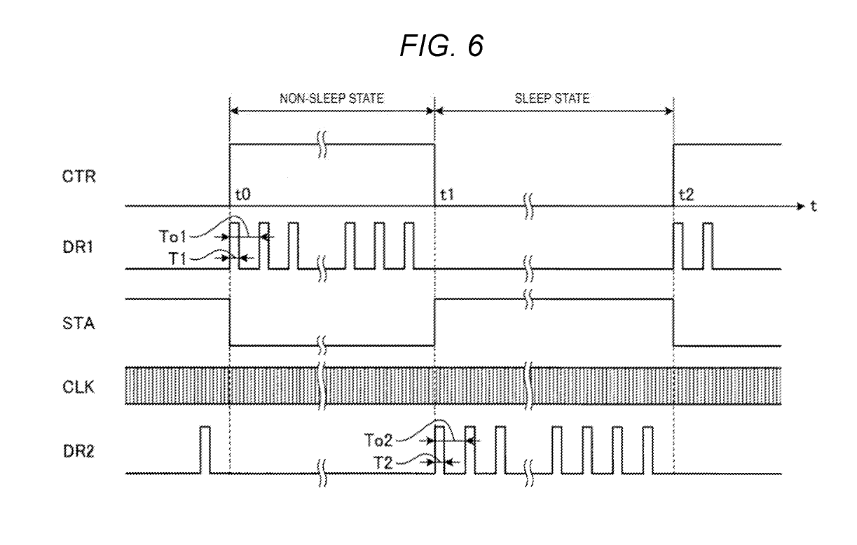

The second adjustment unit 47 is an example of second adjustment means, and adjusts a pulse width T2 and a period To2 (see FIG. 6) of the second driving signal DR2. The second driving signal generation unit 46 functions as the second adjustment unit 47. Specifically, the pulse width T2 and the period To2 of the second driving signal DR2 generated by the second driving signal generation unit 46 are adjusted, and thus the second driving signal DR2 is adjusted so as to cause brightness of the first LED 26a to be substantially equal to brightness of the second LED 26b.

The lighting control unit 48 is an example of selection means. The lighting control unit 48 selects whether the first LED 26a is lit by the first driving signal DR1 or the second LED 26b is lit by the second driving signal DR2. The LED driver 25b in FIG. 2 functions as the lighting control unit 48.

Descriptions of First Driving Signal

Next, the first driving signal DR1 will be described with reference to FIG. 4. FIG. 4 is an example timing chart of the first driving signal DR1.

When the CPU 21 is in non-sleep mode, the CPU 21 generates the first driving signal DR1 illustrated in FIG. 4, and outputs the generated first driving signal DR1 to the lighting control unit 48. The first driving signal DR1 has a rectangular pulse having a pulse width T1 at a predetermined period To1. The first driving signal DR1 is input to an LED lighting circuit in the lighting control unit 48, and thus causes the first LED 26a to emit light by the pulse.

The first driving signal DR1 is a trigger signal for performing switching between ON/OFF states of the LED lighting circuit. A peak value of a pulse waveform of the first driving signal DR1 may have a level required for driving the LED lighting circuit.

The period To1 and the pulse width T1 of the first driving signal DR1 are set to be predetermined values by the CPU 21, and are adjusted by the first adjustment unit 45. For example, T1 is set and adjusted to be 80 μsec and To1 is set and adjusted to be 256 μsec. As a duty ratio D (D=T1/To1) of the first driving signal DR1 is increased, the first LED 26a lights brighter.

Although not particularly illustrated, the second driving signal DR2 has a pulse waveform which is the same as the waveform of the first driving signal DR1. The second driving signal DR2 is generated by the second driving signal generation unit 46. The pulse width T2 and the period To2 (see FIG. 6) of the second driving signal DR2 are set by the second driving signal generation unit 46 and are adjusted by the second adjustment unit 47. That is, the pulse width T1 and the period To1 of the first driving signal DR1 may be set and adjusted to be different from the pulse width T2 and the period To2 of the second driving signal DR2.

As described above, the first LED 26a is a green LED, and the second LED 26b is an orange LED. In this manner, because the colors of light emitted by the LEDs are different from each other, brightness perceived by a user/operator varies even if the LEDs are lit by the same driving signal. This is because the brightness sensed by a person generally varies depending on the wavelength of light. A value obtained by quantifying the degree of brightness sensed by the eyes of a person is referred to as relative visibility for each wavelength of light. It has been experimentally demonstrated that sensitivity of the eyes of a person is highest for 555 nm light and the sensitivity on the shorter wavelength side and on the longer wavelength side is of this value is reduced.

Thus, when a green LED having a wavelength of about 550 nm and an orange LED having a wavelength, of about 610 nm are lit by the same driving signal, a person will typically sense that the light of the green LED is brighter.

Therefore, the duty ratio of the second driving signal DR2 for driving the orange LED (LED 26b) is adjusted to be greater than the duty ratio of the first driving signal DR1 for driving the green LED (LED 26a such that sensed brightness of the first LED 26a and the second LED 26b are equivalent to each other.

Descriptions of Circuit Configuration of LED Luminance Adjustment Unit

Next, a specific circuit configuration of the LED luminance adjustment unit 40a will be described with reference to FIG. 5. FIG. 5 is an example circuit block diagram of the LED luminance adjustment unit 40a.

The LED luminance adjustment unit 40a includes the CPU 21, the second driving signal generation unit 46, a second adjustment unit 47, and the lighting control unit 48.

The CPU 21 includes the state detection unit 42, the first driving signal generation unit 44, and the first adjustment unit 45. The state detection unit 42 detects whether the CPU 21 is in sleep mode or in non-sleep mode. The CPU 21 outputs a CPU state signal CTR to the second driving signal generation unit 46 and the lighting control unit 48. The CPU state signal CTR indicates whether the CPU 21 is in sleep mode or in non-sleep mode. Specifically, the CPU state signal CTR is a pulse signal which outputs a Hi level when the CPU 21 is in non-sleep mode and outputs a Low level when the CPU 21 is in sleep mode. The CPU 21 outputs the CPU state signal CTR to the second driving signal generation unit 46 and the lighting control unit 48.

The first driving signal generation unit 44 generates the first driving signal DR1 for controlling the lighting state of the first LED 26a and outputs the generated first driving signal DR1 to the lighting control unit 48 when the CPU 21 is in non-sleep mode.

As described above, the first adjustment unit 45 adjusts the pulse width T1 and the period To1 (see FIG. 4) of the first driving signal DR1. Specifically, the first adjustment unit 45 adjusts a parameter when the first driving signal DR1 is generated, in the control program executed by the CPU 21, and thus adjusts the pulse width T1 of the pulse waveform of the first driving signal DR1 and the period To1 thereof.

The second driving signal generation unit 46 is a signal pulse generator and an example of a second signal generation means. The second driving signal generation unit 46 generates the second driving signal DR2 for controlling the lighting state of the second LED 26b and outputs the generated second driving signal DR2 to the lighting control unit 48 when the CPU 21 is in sleep mode.

The second driving signal generation unit 46 also functions as the second adjustment unit 47 which is an example of the second adjustment means. The second adjustment unit 47 adjusts of the pulse width T2 and the period To2 of the second driving signal DR2. Specifically, the second adjustment unit adjusts a parameter when the second driving signal generation unit 46 generates the second driving signal DR2, and thus adjusts the pulse width T2 of the pulse waveform of the second driving signal DR2 and the period To2 thereof. More specifically, the frequency of a clock signal CLK generated by a clock generation circuit 46b is adjusted or the number of clocks counted by a counter circuit 46c for one period of the second driving signal DR2. In this manner, the waveform of the second driving signal DR2 is adjusted.

The first adjustment unit 45 and the second adjustment unit 47 perform adjustment at a timing adjusted before a manufactured label printer 1 is shipped. At this time, a user may manually adjust brightness of the first and the second LEDs 26a and 26b via the first adjustment unit 45 and the second adjustment unit 47 such that the perceived brightness of light emitted by the first and the second LEDs is substantially equal to each other. In the example embodiment described herein, both the first adjustment unit 45 and the second adjustment unit 47 are provided. However, in some embodiments, only one of the first adjustment unit 45 and the second adjustment unit 47 may be provided. For example, the LED luminance adjustment unit 40a can adjust brightness of the first and the second LEDs 26a and 26b to be substantially the same.

The second driving signal generation unit 46 includes a latch circuit 46a, a clock generation circuit 46b, and a counter circuit 46c.

The latch circuit 46a includes a flip flop, for example. The latch circuit 46a reads and holds a mode indicated in the CPU state signal CTR that is output by the CPU 21 at each predetermined time. The latch circuit 46a outputs a latch signal STA indicating a period when the CPU 21 is in sleep mode and a period when the CPU 21 is in non-sleep mode. In the example embodiment described herein, it is assumed that the latch signal STA is a signal obtained by reversing the phase of the CPU state signal CTR. That is, when the latch signal STA has a Hi level, the CPU 21 is in sleep mode. When the latch signal STA has a Low level, the CPU 21 is in non-sleep mode.

The clock generation circuit 46b includes an oscillator and generates a clock signal CLK having a predetermined frequency. It is desirable that the frequency of the clock signal CLK is substantially equal to the clock frequency of the CPU 21.

The counter circuit 46c counts the number of clocks of the clock signal CLK over a period when the latch signal STA output by the latch circuit 46a has a Hi level, that is, a period when the CPU 21 is in sleep mode. The counter circuit 46c generates a pulse signal (second driving signal DR2) having a predetermined pulse width T2, whenever the number of clocks of the clock signal CLK reaches a predetermined count value, that is, in each period To2. The counter circuit 46c outputs the generated second driving signal DR2 to the lighting control unit 48.

The lighting control unit 48 is an example of the selection means. The lighting control unit 48 selects whether the first LED 26a is lit by the first driving signal DR1 which is output by the CPU 21 or the second LED 26b is lit by the second driving signal DR2 which is output by the second driving signal generation unit 46.

The lighting control unit 48 includes a selector circuit 48a, an LED lighting unit 48b, and an LED lighting unit 48c. The lighting control unit 48 is connected to a circuit in which the CPU is not included.

The selector circuit 48a selects and outputs the first driving signal DR1 or the second driving signal DR2, based on the CPU state signal CTR. Specifically, when the CPU state signal CTR has a Hi level, that is, when the CPU 21 is in non-sleep mode, the selector circuit 48a selects the first driving signal DR1 and outputs the selected first driving signal DR1 from an output terminal O1 of the selector circuit 48a. At this time, a signal of a Low level is output from an output terminal O2 of the selector circuit 48a. When the CPU state signal CTR has a Low level, that is, when the CPU 21 is in sleep mode, the selector circuit 48a selects the second driving signal DR2 and outputs the selected second driving signal DR2 from the output terminal O2 of the selector circuit 48a. At this time, a signal of a Low level is output from the output terminal O1 of the selector circuit 48a.

The LED lighting unit 48b includes a switching element Tr1 such as a transistor, and lights the first LED 26a which is connected to a DC power supply Vcc via a resistor R. The LED lighting unit 48c includes a switching element Tr2 such as a transistor, and lights the second LED 26b which is connected to the DC power supply Vcc via a resistor R. The LED lighting unit 48b and the LED lighting unit 48c correspond to the LED driver 25b (see FIG. 2).

Descriptions of Action of LED Luminance Adjustment Unit

Next, an action of the LED luminance adjustment unit 40a will be described with reference to FIG. 6. FIG. 6 is a timing chart illustrating ON state of the LED luminance adjustment unit 40a.

The CPU state signal CTR is a pulse signal which outputs a Hi level when the CPU 21 is in non-sleep mode, and outputs a Low level when the CPU 21 is in sleep mode. Here, as illustrated in FIG. 6, it is assumed that the CPU 21 is in non-sleep mode for a period of a time point t0 to a time point t1, and is in sleep mode for a period of the time point t1 to a time point t2.

As illustrated in FIG. 4, the first driving signal DR1 is a rectangular pulse signal which is generated by the CPU 21 and has a pulse width T1 is generated in a predetermined period To1. As illustrated in FIG. 6, the first driving signal DR1 is generated only when the CPU 21 is in non-sleep mode.

The latch signal STA is a signal obtained by latching the CPU state signal CTR in the latch circuit 46a illustrated in FIG. 5. In the example embodiment described herein, it is assumed that the latch signal STA is a signal obtained by reversing the phase of the CPU state signal CTR.

The clock signal CLK is a clock signal which is generated by the clock generation circuit 46b and has a predetermined frequency. As described above, it is desirable that the frequency of the clock signal CLK is substantially equal to the clock frequency of the CPU 21.

As described above, the second driving signal DR2 is a rectangular pulse signal which is generated by the second driving signal generation unit 46 and has a pulse width T2 is generated in a predetermined period To2. As illustrated in FIG. 6, the second driving signal DR2 is generated only when the CPU 21 is in sleep mode. In FIG. 6, it is assumed that the first driving signal DR1 and the second driving signal DR2 have the same waveform. That is, T1=T2 and To1=To2 are assumed.

The second driving signal generation unit 46 generates the second driving signal DR2 in a manner that a pulse having a predetermined width T2 is generated at a timing when the predetermined number of clocks is counted in the clock signal CLK, in a period when the CPU 21 is sleep mode (in a period when the latch signal STA has a Hi level).

In the example embodiment described herein, a green LED is used as the first LED 26a and an orange LED is used as the second LED 26b. However, the first LED 26a and the second LED 26b the first LED 26a and the second LED 26b may instead emit light of the same color. In this case, if the first driving signal DR1 and the second driving signal DR2 are set to have the same pulse waveform, in principle, the first LED 26a and the second LED 26b emit light at the substantially same brightness. However, in practice, due to residual differences among LEDs, there may be a difference in brightness of emitted light from the first LED 26a and the second LED 26b. Therefore, with the first adjustment unit 45 or the second adjustment unit 47 it may still be possible to adjust the brightness of light emitted from the first LED 26a and the second LED 26b for matching brightness levels.

In the example embodiment described above, in the label printer 1 is presented as an example of an electronic device having a LED luminance adjustment unit (also referred to as light emission luminance adjustment device) 40a, the state detection unit 42 detects whether the CPU 21 is in sleep mode or in non-sleep mode. The first driving signal generation unit (also referred to as a first signal generation means) 44 generates and outputs the first driving signal DR1 for controlling the lighting state of the first LED 26a indicating the operation mode of the label printer 1, when it is detected that the CPU 21 is in non-sleep mode. The second driving signal generation unit 46 generates and outputs the second driving signal DR2 for controlling the lighting state of the second LED 26b indicating the operation mode of the label printer 1 when it is detected that the CPU 21 is in sleep mode, such that perceived brightness when the second LED 26b is lit is substantially equal to perceived brightness when the first LED 26a is lit by the first driving signal DR1. The lighting control unit 48 selects the driving signal such that the first LED 26a is lit by the first driving signal DR1 when the CPU 21 is in non-sleep mode, and the second LED 26b is lit by the second driving signal DR2 when the CPU 21 is in sleep mode. Accordingly, regardless of whether the CPU 21 is in sleep mode or is in non-sleep mode, it is possible to light the LEDs 26a and 26b for indicating the operation mode of the label printer 1, at the substantially same brightness.

In the label printer 1, the second driving signal generation unit 46 is connected to a circuit in which the CPU 21 is not included. When the CPU 21 is in sleep mode, the second LED 26b is lit by the second driving signal DR2 which is generated by the second driving signal generation unit 46. Thus, it is possible to reduce power consumption of the label printer 1.

In the label printer 1, the LEDs having different colors are lit by the first driving signal DR1 and the second driving signal DR2, respectively. Thus, it is possible to clearly indicate whether the label printer 1 is in sleep mode or in non-sleep mode, based on the color of light emitted by the LED.

In the label printer 1, the lighting control unit 48 selects whether the first LED 26a is lit by the first driving signal DR1 or the second LED 26b is lit by the second driving signal DR2. Thus, it is possible to reliably and easily switch between ON/OFF states of the LEDs 26a and 26b, in accordance with the operation mode of the label printer 1.

In the label printer 1, the first driving signal generation unit 44 further includes the first adjustment unit 45 configured to adjust the pulse width T1 and the period To1 of the first driving signal DR1. The second driving signal generation unit 46 further includes the second adjustment unit 47 configured to adjust the pulse width T2 and the period To2 of the second driving signal DR2. Thus, it is possible to adjust brightness of light emitted from the first LED 26a and the second LED 26b to be at the substantially same. It is also possible to adjust brightness of light emitted from the first LED 26a and the second LED 26b to be at the substantially same brightness, even if the colors of light emitted by the LED 26a and the LED 26b are different from each other.

### Second Embodiment

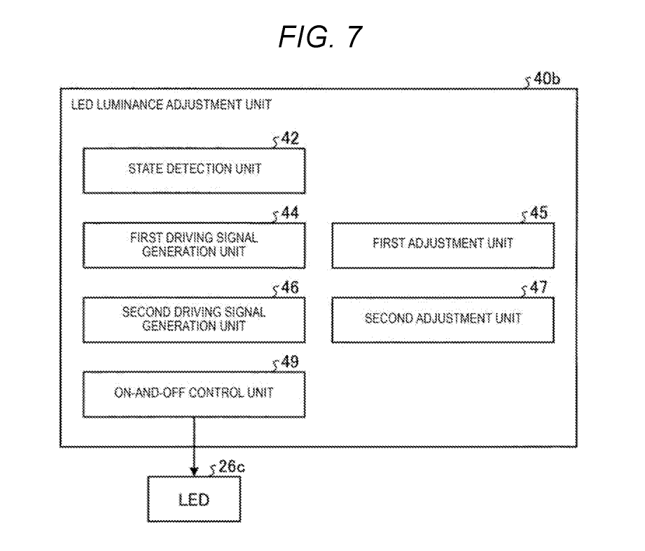

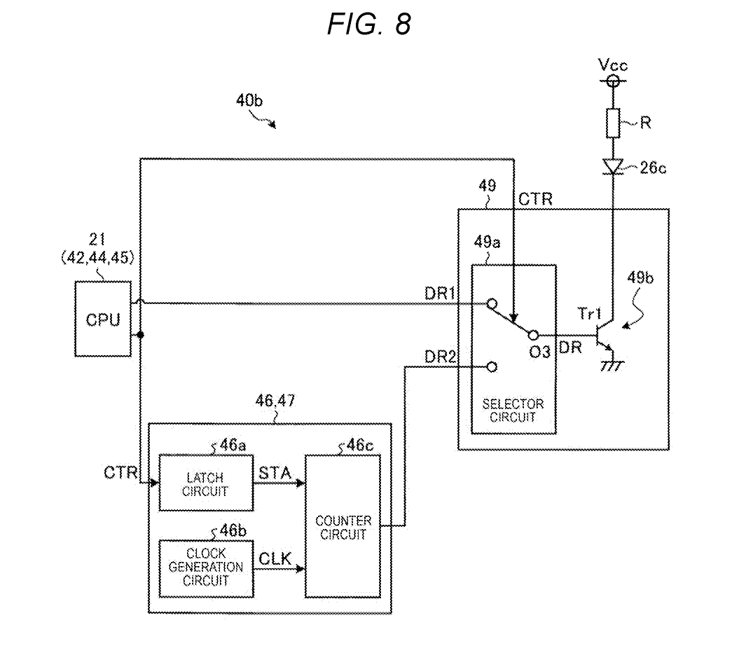

Next, a label printer according to a second embodiment will be described In this example embodiment, a label printer is different from in the label printer 1 according to the first embodiment in that there is only one LED 26c (see FIG. 8) in the mode indicator 14 rather than two separate LEDs (26a & 26b) as in the first embodiment. FIG. 7 is a block diagram of an LED luminance adjustment unit 40b as an example of a light emission luminance adjustment device in the label printer according to the second embodiment.

The LED luminance adjustment unit 40b includes a state detection unit 42, a first driving signal generation unit 44, a first adjustment unit 45, a second driving signal generation unit 46, a second adjustment unit 47, and a lighting control unit 49. The components other than the lighting control unit 49 have the same functions as those of the functional unit described in the first embodiment. The lighting control unit 49 is an example of the selection means and lights the LED 26c by one of the first driving signal DR1 and the second driving signal DR2. The LED driver 25b in FIG. 2 functions as the lighting control unit 49.

Descriptions of Circuit Configuration of LED Luminance Adjustment Unit

Next, a specific circuit configuration of the LED luminance adjustment unit 40b will be described with reference to FIG. 8. FIG. 8 is an example circuit block diagram of the LED luminance adjustment unit 40b.

The LED luminance adjustment unit 40b includes a CPU 21, a second driving signal generation unit 46, a second adjustment unit 47, and a lighting control unit 49.

The configurations and the functions of the CPU 21 and the second driving signal generation unit 46 and the second adjustment unit 47 are as described in the first embodiment.

The lighting control unit 49 is an example of the selection means. The lighting control unit 49 selects any one of the first driving signal DR1 output by the CPU 21 and the second driving signal DR2 output by the second driving signal generation unit 46. The lighting control unit 49 lights the LED 26c by using the selected first driving signal DR1 or second driving signal DR2.

The lighting control unit 49 includes a selector circuit 49a and an LED lighting unit 49b. The selector circuit 49a selects any one of the first driving signal DR1 and the second driving signal DR2 based on the CPU state signal CTR. Specifically, when the CPU state signal CTR has a Hi level, that is, when the CPU 21 is in non-sleep mode, the selector circuit 49a selects the first driving signal DR1 and outputs the selected first driving signal DR1 from an output terminal O3, as a driving signal DR. When the CPU state signal CTR has a Low level, that is, when the CPU 21 is in sleep mode, the selector circuit 49a selects the second driving signal DR2 and outputs the selected second driving signal DR2 from the output terminal O3, as the driving signal DR.

The LED lighting unit 49b includes a switching element Tr1 such as a transistor, and lights the LED 26c which is connected to a DC power supply Vcc via a resistor R. The LED lighting unit 49b corresponds to the LED driver 25b (see FIG. 2).

Descriptions of Action of LED Luminance Adjustment Unit

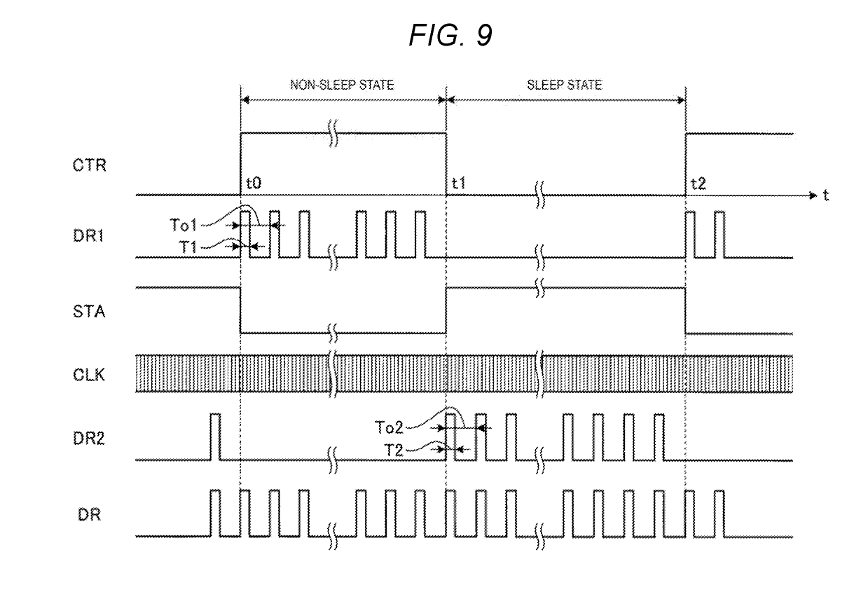

Next, an action of the LED luminance adjustment unit 40b will be described with reference to FIG. 9. FIG. 9 is a timing chart illustrating ON state of the LED luminance adjustment unit 40b.

The CPU state signal CTR, the first driving signal DR1, the latch signal STA, the clock signal CLK, and the second driving signal DR2 which are illustrated in FIG. 9 are the same as the signals described in the first embodiment (see FIG. 6), respectively. Similar to the first embodiment, it is assumed that the first driving signal DR1 and the second driving signal DR2 have the same pulse waveform. That is, T1=T2 and To1=To2 are assumed.

The driving signal DR has a form obtained by adding the first driving signal DR1 and the second driving signal DR2. In the example embodiment described herein, since T1=T2 and To1=To2 are set, the driving signal DR has a pulse waveform of the period To1 and the pulse width T1. Since the LED 26c is lit by the driving signal DR, the LED 26c lights at the substantially same brightness when the CPU 21 is in sleep mode and when the CPU 21 is in non-sleep mode. Thus, the label printer 1 can clearly indicate that the label printer 1 is in a sleep mode or in non-sleep mode.

In the label printer 1 including the LED luminance adjustment unit (light emission luminance adjustment device) 40b according to the second embodiment, the first driving signal DR1 and the second driving signal DR2 have the same waveform. Thus, it is possible to light the LED 26c at the substantially same brightness when the CPU 21 is in sleep mode and when the CPU 21 is in non-sleep mode.

In the label printer 1 according to the second embodiment, the first driving signal generation unit 44 further includes the first adjustment unit 45 configured to adjust the pulse width T1 and the period To1 of the first driving signal DR1. The second driving signal generation unit 46 further includes the second adjustment unit 47 configured to adjust the pulse width T2 and the period To2 of the second driving signal DR2. Accordingly, even though brightness of the LED 26c in a plurality of different label printers 1 may vary due to residual differences, it is possible to perform adjustment to light LEDs 26c at the substantially same brightness.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A light emission luminance adjustment device, comprising:
a first signal pulse generator configured to generate a first driving signal for controlling a lighting state of a first indicator light; and
a second signal pulse generator configured to generate a second driving signal controlling a lighting state of a second indicator light,
wherein the first driving signal and the second driving signal cause the first indicator light and the second indicator light to have substantially equal brightness when lit.

2. The light emission luminance adjustment device according to claim 1, further comprising:
a controller configured to power the first signal pulse generator.

3. The light emission luminance adjustment device according to claim 2, wherein
the first driving signal drives the first indicator light when the controller is in a sleep mode, and
the second driving signal drives the second indicator light when the controller is in a non-sleep mode.

4. The light emission luminance adjustment device according to claim 3, further comprising:
a selector circuit to select whether the first indicator light is driven by the first driving signal or the second indicator light is driven by the second driving signal.

5. The light emission luminance adjustment device according to claim 3, wherein
the controller is further configured to detect whether the controller is in the sleep mode or in the non-sleep mode.

6. The light emission luminance adjustment device according to claim 1, wherein
at least one of the first signal pulse generator and the second signal pulse generator is configured to vary a pulse width and a period of a driving signal.

7. The light emission luminance adjustment device according to claim 1, wherein the first indicator light and the second indicator light are a same color.

8. A light emission luminance adjustment device, comprising:
a first signal pulse generator configured to generate a first driving signal for controlling a first lighting state of an indicator light; and
a second signal pulse generator configured to generate a second driving signal controlling a second lighting state of the indicator light,
wherein the first driving signal and the second driving signal cause the indicator light to have a substantially equal brightness in the first and second lighting states.

9. The light emission luminance adjustment device according to claim 8, further comprising:
a controller configured to power the first signal pulse generator.

10. The light emission luminance adjustment device according to claim 9, wherein
the first driving signal drives the indicator light wherein the controller is in a sleep mode, and
the second driving signal drives the indicator light when the controller is in a non-sleep mode.

11. The light emission luminance adjustment device according to claim 10, further comprising:
a selector circuit to select whether the first indicator light is driven by the first driving signal or by the second driving signal.

12. The light emission luminance adjustment device according to claim 10, wherein
the controller is further configured to detect whether the controller is in the sleep mode or in the non-sleep mode.

13. The light emission luminance adjustment device according to claim 8, wherein
at least one of the first signal pulse generator and the second signal pulse generator is configured to vary a pulse width and a period of a driving signal.

14. An electronic device, comprising:
a first light indicator configured to be on when the electronic device is in sleep mode;
a second light indicator configured to be on when the electronic device is in non-sleep mode;
a first signal pulse generator configured to generate a first driving signal for controlling a lighting state of a first indicator light when the electronic device is in a non-sleep mode; and
a second signal pulse generator configured to generate a second driving signal controlling a lighting state of the second indicator light when the electronic device is in a sleep mode,
wherein the first driving signal and the second driving signal cause the first indicator light and the second indicator light to have a substantially equal brightness when lit.

15. The electronic device according to claim 14, further comprising:
a controller configured to power the first signal pulse generator.

16. The electronic device according to claim 15, wherein
the first driving signal drives the first indicator light wherein the controller is in a sleep mode, and
the second driving signal drives the second indicator light when the controller is in a non-sleep mode.

17. The electronic device according to claim 16, further comprising:
a selector circuit to select whether the first indicator light is driven by the first driving signal or the second indicator light is driven by the second driving signal.

18. The electronic device according to claim 16, wherein
the controller is further configured to detect whether the controller is in the sleep mode or in the non-sleep mode.

19. The electronic device according to claim 14, wherein
at least one of the first signal pulse generator and the second signal pulse generator is configured to adjust a pulse width and a period of a driving signal.

20. The electronic device according to claim 14, wherein the first indicator light and the second indicator light are a same color when lit.
